(19) United States
(12) Patent Application Publication
(10) Pub. No.: US 2011/0280545 A1
(43) Pub. Date: Nov. 17, 2011

(54) MULTI-CHANNEL PARALLEL DIGITAL VIDEO RECORDER

(76) Inventor: Lawrence Kates, Corona Del Mar, CA (US)

(21) Appl. No.: 12/724,325

(22) Filed: Mar. 15, 2010

Related U.S. Application Data
(63) Continuation of application No. 11/361,063, filed on Feb. 23, 2006, now abandoned.

(51) Int. Cl. H04N 5/76

(52) U.S. Cl. 386/235; 386/E05.001

(57) ABSTRACT

A multiple channel parallel digital video recorder system records simultaneously and continuously the favorite channels of a user. The recorder system stores programming content for a user to view at a later time. A multimedia control system can be connected to the recorder system and display in a matrix format the stored programming content that is available for review.

### CROSS-REFERENCE TO RELATED APPLICATIONS

This application claims priority to U.S. application Ser. No. 11/361,063, filed Feb. 23, 2006, entitled MULTI-CHANNEL PARALLEL DIGITAL VIDEO RECORDER; the entirety of which is hereby incorporated herein by reference.

### BACKGROUND OF THE INVENTION

1. Field of the Invention

The present invention relates to systems and methods for simultaneously recording multiple channels of video or audio programming.

2. Description of the Related Art

Multimedia devices such as VCRs, DVD players, MP3 players, cassette players, CD players, SetTop Boxes (STBs) for cable and satellite and internet television, and the new class of Personal Video Recorders (PVRs) are extremely popular with consumers. Almost every household in the United States has at least one of these devices.

Another common complaint is that users do not wish to review commercial advertisements while reviewing their desired programming content. Moreover, the volume at which commercial advertisements are presented is often much louder than the desired programming content, thereby, requiring the user to turn down the volume of their speaker output.

Another common user complaint is that a user must know in advance what to record, thereby, making it necessary for a user to consult programming schedules or guides. There currently exist PVRs that will record programming based on a user's selected preferences. However, even these programming recording schemes require the PVR device to know in advance the programming schedule of a particular program of interest because these recording schemes record based on subject matter. For example, if the PVR device detects that the user prefers to view war movies, the PVR will search upcoming programming schedules for future movies with a subject matter related to war. For this scheme to operate, the PVR needs to know the schedule of future programming.

Another common problem is users are often too busy to program their PVRs to record particular programs of interest. Additionally, users often have difficulty in figuring out how to program their PVRs to record particular programs of interest. Moreover, some users find programming PVRs to be cumbersome. Other users are merely too lazy to program their PVRs and would rather the PVRs program themselves.

Another common complaint is users often wish they could review programming that was presented yesterday or a previous day. Had the user known of the programming schedule in advance, the user would have recorded the program of interest. Or had the user been knowledgeable enough to program the user's PVR, the user would have programmed the PVR to record the program of interest. Alternatively, had the user had time to program the PVR, then user might have recorded the program of interest.

Typically, such programming is presented on the user's favorite channels, which the user consistently reviews out of preference and habit. Although a user may occasionally review channels at random (channel surfing), a typical user usually switches between the user's favorite channels while ignoring all other channels that may be available to the user. Although a user may have access to over 200 channels, a user, out of habit and preference, may only consistently watch ten of these available channels. For example, a user may only be interested in current events, and therefore, the user consistently watches only the 24-hour news channels.

Another common complaint is that the storage space on PVRs is too small. A related complaint is that the storage space can become full, thereby, preventing a user from recording a desired program of interest. Another related complaint is that a user may never have an opportunity to review programming content that has been stored on a PVR, however, to remove such content the user must actively search for the programming content with the PVR library and delete the program. If the user fails to delete such programming content, then the user may be prevented from recording more desirous programming content. Additionally, typical PVRs cannot continuously record channels of interest because of storage space restrictions.

Another common complaint is that user's have difficulty reviewing programming stored on a user's PVR because the user has difficulty in locating the program of interest. To review a desired program that has been stored on the user's PVR, a user typically must search a text-based menu representing the stored programming available on the PVR. Searching through such a menu can be cumbersome and time consuming for the user. Further, as the storage space of PVRs increases, PVRs will be able to store increasingly more programming content, thereby, increasing the length and size of such a menu. Longer menus make it even more difficult for a user to locate and search for desired programming content.

Another common complaint is that user's typically do not have enough time to view all the programming that has been stored on a PVR. Although the user may not have sufficient time to review all the programming, the user, nonetheless, desires to sufficiently know the programming content in order to be conversant in the matter. Or the user, nonetheless, desires to sufficiently know the programming content to derive adequate psychic value. Merely presenting the titles of programming content stored on a PVR does not adequately fulfill these needs of a user.

Further, menus used to guide users through options delivered by multimedia devices are also confusing and cryptic. The menus are simplistic and text based. Cursor appearance and movement are rudimentary and the user is easily confused by the non-intuitive uses of menu choices.

Multimedia program schedule information provided by cable and satellite and internet television providers has been physically tied to an archaic display method. Service providers are under the false belief that viewers are conditioned to interpret and understand the television schedule presentation methods that originated from print media such as newspapers.

Television program schedule information has traditionally been displayed either in a columnar or tabular form. The tabular method displays program schedule information as a two-dimensional table. The vertical axis displays the television channel numbers and the horizontal axis displays the time periods. The names of the television programs for each channel are listed horizontally across the table. Each show is listed under the time period during which it is shown.

The columnar method displays the channels and program names under a time heading. TV Guide is an example of the columnar method. This works well for printed matter because the reader looks through the columns for the desired time period and finds all of the channels and program names starting at that time.

A dominant television schedule format is the grid format. This format is popular for displaying television schedule information on the TV screen. The television schedule information is displayed in much the same form as the tabular approach. A two-dimensional table format is laid out. The vertical axis displays the channel numbers or IDs with the horizontal axis displaying half-hour time increments. Programs are blocked out within the table. A show is represented by a rectangular colored block. This block extends horizontally from the program start time to the program end time.

The viewer either scrolls through the channel list or it is rotated automatically. Information beyond the time period is not displayed and only shifts to the right as time advances.

The problem with the grid format is that it is limited by the television resolution, screen size, and viewing distance. This limits the information displayed an hour or two, and the channel list to around seven channels. Additionally, some applications attempt to place advertising information within the grid format. This leads to a visual overload of information to the viewer and a cluttered appearance.

STBs and PVRs use the television screen to display programming information. The user is forced to use a remote control or other device to manipulate a cursor on the screen to select programming. This is a cumbersome and frustrating process and the user cannot watch a program or movie while scrolling through the programming list

### SUMMARY

These and other problems are solved by a multiple channel parallel digital video recorder system that records a plurality of channels continuously. This device records multiple channels of video or audio programming simultaneously and continuously such that user need not configure the device to record programs of interest. Additionally, the user need not consult programming schedules to determine when to program the device, because the device can continuously record or the user can program a combination of continuous or programmed recording.

In one embodiment, the recorder system can record multiple channels of television programming simultaneously and continuously. In one embodiment, the recorder system can be configured to record multiple radio channels simultaneously and continuously. In one embodiment, the recorder system can record both radio and television channels simultaneously and continuously. In one embodiment, the recorder system can record more radio programming than video programming.

In one embodiment, the recorder system is configured to allow the user to program the recorder system to record a plurality of desired programming content presented on a plurality of channels at different time periods. In one embodiment, the recorder system is configured to allow the user to program the recorder system to record a plurality programming content that is simultaneously presented on a plurality of channels. In one embodiment, the recorder system is configured to allow the user to program a combination of continuous and periodic recording settings.

In one embodiment, the recorder system contains a storage medium for recording programming content for the user to review at a later time. In one embodiment, the recorder system starts recording at the beginning of the storage medium when the system reaches the end of the storage medium such that the recorder system can record continuously. In one embodiment, the recorder system alerts the user that the storage medium is full. In one embodiment, the full storage medium alert is an audio sound. In one embodiment, the full storage medium alert is a visual signal. In one embodiment, the full storage medium alert is a combination of audio and visual signals. In one embodiment, the recorder system allows the user to selectively delete recorded programming content before the recorder system uses all the available free space in the storage medium, thereby, allowing the recorder system to continuously record new programming content without recording over previous stored content.

In one embodiment, the user can access the recorder system from a remote location through a communications network to delete recorded programming content such that memory is freed within the storage medium to record additional programming content without recording over already stored programming content. In one embodiment, the recorder system sends a “full storage” alert to the user at a remote location through a communication network. In one embodiment, the recorder system sends a full storage alert to the user at a remote location through an email protocol. In one embodiment, the recorder system sends a full storage alert to the user at a remote location through a text messaging protocol. In one embodiment, the recorder system can predict, based on past viewing preferences, whether a user will likely review a particular program stored in the storage medium. In one embodiment, the recorder system can automatically delete programming content that the user is not likely to review.

In one embodiment, the recorder system can be configured to record simultaneously and continuously the user's favorite channels so that the user need not consult a programming schedule to determine how to configure the recorder system. In one embodiment, the user can configure the device to automatically build a favorite channels list by monitoring the user's reviewing preferences and habits over a period of time, and then recording the ten most frequently watched channel's by the user. By automatically building the favorite channels list, the recorder system frees users from the difficulty and hassle and confusion often involved in configuring PVR devices. In one embodiment, the user can build a favorite channels list by selecting a subject matter such that the recorder system has a list of pre-determined channels that correspond to the selected subject matter. In one embodiment, the user can build a favorite channels list by selecting a season, such as, baseball season. In one embodiment, the user can configure the recorder system to have multiple lists of favorite channels.

In one embodiment, the recorder system is configured not to record a plurality of channels on the user's favorite channels list when the user has programmed the recorder system to record desired programming content. In one embodiment, the recorder system is configured to allocate memory space in the storage medium to record programming content that the user programmed the recorder system to record such that memory space allocated for storing programming content from channels recorded on a continuous basis is reduced. In one embodiment, the recorder system will not delete recorded programming content that the user specifically programmed the recorder system to record. In one embodiment, the recorder system is configured to store programming content that the user programmed the recorder system to record to a period of time set by the user. In one embodiment, the recorder system is configured to store programming content that the user programmed the recorder system to record for a default period of time set by the user during the initial setup of the recorder system or set by the manufacturer during the manufacture of the recorder system.

In one embodiment, the recorder system is configured to reprioritize the user's favorite channels list when the user later programs the recorder system to record a plurality of channels such that the recorder system will only record on a continuous basis the high priority channels from the user's favorite channels list. In one embodiment, the recorder system reprioritizes the user's favorite channels list based on the user's designation of priority during the setup of the favorite channels list. In one embodiment, the recorder system reprioritizes the user's favorite channels list based on past viewing habits of the user. In one embodiment, the recorder system reprioritizes the user's favorite channels list based a random selection. In one embodiment, the recorder system reprioritizes the user's favorite channels list based a combination of past viewing habits and random selection and user designation. In one embodiment, the recorder system reprioritizes the user's favorite channels list based preferences obtained from a remote server. In one embodiment, the recorder system provides the user with a reward, for example a cash reward or gift certificate, for setting up the recorder system to allow a remote server to reprioritize the user's recorder system.

In one embodiment, the user changes the favorite channels list by accessing the recorder system from a remote location through a communications network. In one embodiment, the user configures the multiple lists of the favorite channels lists such that there is a list for multiple users of the recorder system. In one embodiment, the user configures the recorder system to record the channels in one list during a certain period of time while configuring the recorder system to record the channels of another list during another period of time.

In one embodiment, the recorder system can detect whether the user is reviewing programming content from a particular channel with a favorite channels list. In one embodiment, the recorder system suggests to the user an alternate channel for replacing an infrequently watched channel in the user's favorite channel list. In one embodiment, the recorder system automatically adds or deletes channels from a user's favorite channels list based on detecting changes in the user's view habits or preferences. In one embodiment, the recorder system offers the user a reward for adding a specific channel to the user's favorite channel list, and this process is known as an upsell. In one embodiment, the recorder system allows the user to recommend programming content to other users or individuals at remote locations. In one embodiment, the recorder system offers a reward to the user for recommending channels or programming content to other individuals using recorder systems at remote locations. In one embodiment, the recorder system suggests to the user a channel for adding to the user's favorite channels list based on the preferences of other individuals using recorder systems at other locations.

In one embodiment, the recorder system is configured to recommend to the user programming content based on monitoring the past reviewing habits and preferences of the user. In one embodiment, the recorder system prioritizes the programming content based on monitoring the past reviewing habits and preferences of the user. In one embodiment, the recorder system first deletes or records over programming content that has the lower priority instead of deleting or recording over programming content with the higher priority. In one embodiment, the recorder system prioritizes different segments of particular programming content, such as giving women's figuring skating higher priority over men's figure skating. In one embodiment, the recorder system automatically deletes or records over segments of a program that have lower priority such that only higher priority segments of a program are stored.

In one embodiment, the recorder system is configured to record simultaneously and continuously the user's favorite channels and store the recorded programming for some amount of time to allow the user to review the programming that has already been presented. This allows the user to review programming that the user failed to know of at the time the programming was presented. In one embodiment, the recorder system is configured with a default setting such that the recorder system records simultaneously and continuously the user's primary favorite channels list.

In one embodiment, the recorder system is configured to automatically remove commercial advertisements from programming content. In one embodiment, the recorder system automatically removes commercials by searching the recorded programming content for changes in volume to detect commercial advertisements. In one embodiment, the recorder system automatically detects commercial advertisements by detecting changes in volume, in which case the recorder system will stop recording and begin recording again when the recorder system detects a decrease in volume. In one embodiment, the recorder system automatically removes commercials by searching the recorded programming content for the absence of the programming distributor's logo such that all recorded content that does not present the programming distributor's logo is removed. In one embodiment, the recorder system automatically detects commercial advertisements by detecting the absence of the programming distributor's logo, in which case the recorder system will stop recording and begin recording again when the recorder system detects the presence of the programming distributor's logo.

In one embodiment, the recorder system is configured to automatically remove commercial advertisements from recorded programming. In one embodiment, the recorder system is connected through a communications network, such as the Internet, to a remote server. In one embodiment, the remote server contains a database of information regarding the start and stop time of commercial advertisements for all available programming channels. In one embodiment, the recorder system is configured to obtain and use this information to remove all commercial advertisement content from the programming recorded and stored in the recorder system. In one embodiment, the recorder system is configured to obtain this information from the database in real time, thereby, allowing the recorder system to stop recording when commercials are playing and begin recording again when commercials have finished playing. In one embodiment, the recorder system is configured to use this information to display all commercials for the user to review continuously or selectively. In one embodiment, the recorder system is configured to retrieve weather information from the remote server. In one embodiment, the recorder system is configured to detect severe weather conditions based on the retrieved weather information such that the system records an alternate list of favorite channels. In one embodiment, the recorder system is configured to detect severe weather conditions based on the retrieved weather information such that the system alters the recording schedule of the system.

In one embodiment, the database of commercial information that is contained in the remote server is programmed into the server by individuals watching various programming channels such that whenever a commercial advertisement is presented these individuals record the start time and end time of commercial advertisements. In one embodiment, the individuals monitoring programming channels enter title, description, and start and end time data information regarding programming content into a programming information database, which is contained in the remote server. In one embodiment, these individuals are located in a central location. In one embodiment, these individuals are located at remote locations, such as the individual's home, in which case the individuals connect to the remote server through a communications network, such as the Internet.

In one embodiment, the recorder system is configured to use programming information, such as, for example, a program title, description, program start time, program end time, etc., received from the programming information database to identify programming content stored in the recorder system. In one embodiment, the recorder system is configured to associate the program information with programming content stored in the recorder system to allow functions, such as: jump to end of program; jump to beginning of program; skip commercials; show program title, etc. In one embodiment, the recorder system sends the title, description, and start and end time and date data information to a multimedia control system such that the multimedia control system can associate such data information with programming content stored on the recorder system. In one embodiment, the recorder system is configured to use the title, description, and start and end time and date data information to determine the start and end points of particular programming content stored in the recorder system.

In one embodiment, the recorder system is configured to allow the user to inform the recorder system that a commercial advertisement is currently being presented such that the recorder system will tag the indicated portion of the stored programming content as a commercial advertisement. In one embodiment, the recorder system is connected to a multimedia control system that includes a “fast-forward commercial” button that is configured to allow the user to fast forward through a portion of a program and mark this portion as a commercial advertisement. In one embodiment, the user holds onto the “fast-forward commercial” button when a commercial begins and releases the button when the commercial ends. In one embodiment, the recorder system is configured to allow the user to select the “fast-forward commercial” button while the system is recording the programming content such that the recorder system tags the programming content portion as a commercial advertisement. In one embodiment, the recorder system is configured to stop recording while the user holds the “fast-forward commercial” button while the system is recording a particular programming content that the user is simultaneously reviewing in real time In one embodiment, the recorder system is configured to automatically delete the portion of programming content marked as commercial advertisements.

In one embodiment, the recorder system is configured to send this commercial tagging information to a remote server though a communications network for storage in a commercial information database. In one embodiment, the remote server is configured to receive a plurality of commercial tagging information from a plurality of users over a communications network. In one embodiment, the remote server is configured to average the commercial tagging information received from a plurality of users such that anomalies are eliminated. In one embodiment, the remote server is configured to delete commercial tagging information received from a plurality of users that is dissimilar to other information received from other users. In one embodiment, the remote server is configured to apply an algorithm to the commercial tagging information received from a plurality of users so as to determine the start and end timing information for commercial advertisements.

In one embodiment, the remote server also contains a database for upsell information. In one embodiment, a recorder system is configured to periodically connect to the remote server to retrieve upsell information. In one embodiment, the remote server automatically sends upsell information to a recorder system. In one embodiment, the recorder system sends information back to the remote server for storing in upsell database if a user accepts the upsell.

In one embodiment, the recorder system is configured to store a watchlist. In one embodiment, the user inputs the titles of desired programming content. In one embodiment, the recorder system is configured to compare the watchlist before deleting a particular programming content from the storage medium. In one embodiment, the recorder system is configured to store particular programming content if the title of the program appears in the watchlist. In one embodiment, the recorder system is configured to delete or record over particular programming content if the title of the program does not appear in the watchlist.

In one embodiment, the recorder system can detect whether the user has not activated the system for an extended period of time. In one embodiment, the recorder system stores programming content on an alternative storage medium when the system detects that the user has not activated the recorder system for an extended period of time. In one embodiment, the recorder system stores programming content that is about to be deleted or recorded over on to a DVD disc when the recorder system detects that the user has not activated the system for an extended period of time.

In one embodiment, the recorder system can detect whether the user has not reviewed recorded programming content for a period of time, for example, one week. In one embodiment, the recorder system automatically deletes recorded programming content when the recorder system detects that the user has not reviewed the programming content for a period of time, for example, a week.

In one embodiment, the recorder system detects whether duplicate programming is being stored in the storage medium. In one embodiment, the recorder system deletes or records over duplicate programming content such that one copy of the programming content remains in the storage medium.

In one embodiment, the recorder system is configured to record programming content at multiple levels of resolution. In one embodiment, the recorder system is configured to record programming content at a low resolution when the recorder system is continuously recording the user's favorite channels list. In one embodiment, the recorder system is configured to record programming content at a high resolution when the recorder system is recording programming content that the user has specifically programmed that recorder system to record. In one embodiment, the recorder system is configured to record programming content utilizing multiple levels of compression algorithms. In one embodiment, the recorder system is configured to record programming content using a high compression algorithm when the recorder system is continuously recording the user's favorite channels list. In one embodiment, the recorder system is configured to record programming content using a low compression algorithm when the recorder system is recording programming content that the user has specifically programmed to the recorder system to record.

In one embodiment, the recorder system connects to a multimedia control system through a radio-frequency interface. In one embodiment, the recorder system connects to a multimedia control system through a direct wire interface. In one embodiment, the recorder system connects to a multimedia control system through an InfraRed connection. In one embodiment, the recorder system connects to a multimedia control system through a combination of the interfaces mentioned above.

In one embodiment, the multimedia control system includes a processor, a touch-screen display, a communications interface to receive title and description information over at least one communications channel, and one or more interfaces for connecting to the recorder system. In one embodiment, the multimedia control system includes an InfraRed interface for connecting to the recorder system. In one embodiment, the multimedia control system includes a radio-frequency interface for connecting to the recorder system. In one embodiment, the multimedia control system includes a direct wire interface.

In one embodiment, the communications channel includes a computer network. In one embodiment, the communications channel includes an Internet connection. In one embodiment, the communications channel includes a wireless networking channel. In one embodiment, the communications interface includes a satellite-radio receiver. In one embodiment, the communications interface includes a local area network interface. In one embodiment, the communications interface includes a wireless local area network interface.

In one embodiment, the multimedia control system receives information regarding programming content stored in the recorder system, and presents the stored programming content information on the touch-screen display. In one embodiment, the stored programming content information is displayed in a matrix format such that a relatively large number of programs can be displayed on a single control screen. In one embodiment, the matrix format includes an array of graphical user interface buttons corresponding to programming content stored on the recorder system. In one embodiment, each button displays the title and description and start and end time and date recorded and duration information of the corresponding stored programming content. In one embodiment, each button displays a frame of the corresponding stored programming content. In one embodiment, each button displays a video segment of the corresponding stored programming content. In one embodiment, some of the buttons in the array display title and description information, while other buttons display a video frame, and still other buttons display a video segment.

In one embodiment, the multimedia control system processor receives through the communications interface title and description and start and end time and date data information regarding particular programs stored on the recorder system and displays this information on the touch-screen display as described above. In one embodiment, the multimedia control system processor receives title, description, and start and end time and date data information from the recorder system regarding particular programs stored on the recorder system and displays this information on the touch-screen display as described above. In one embodiment, the multimedia control system processor receives title, description, and start and end time data information from a remote server regarding particular programs stored on the recorder system and displays this information on the touch-screen display as described above. In one embodiment, the multimedia control system processor is configured to use the title, description, and start and end time and date data information to determine the necessary programming content data information to be retrieved from the recorder system.

In one embodiment, the user selects a stored program to review by twice touching the button that corresponds to the stored programming content of interest. In one embodiment, the user deletes a stored program by touching the button that corresponds to the stored program, and then touching the delete button, which is also located on the multimedia control system. In one embodiment, the user simultaneously plays in a matrix format within the touch screen display the stored programming content recorded from all channels on the user's favorite channels list. In one embodiment, the user simultaneously plays in a matrix format on the user's television display the stored programming content recorded from all channels on the user's favorite channels list. In one embodiment, the user activates the sound of one of the playing programs by once touching the button that corresponds to the program of interest.

In one embodiment, the user views a shortened version of the stored program, called a highlight, by touching the button that corresponds to the desired program and then touching the highlights button, which is also located on the multimedia control system. In one embodiment, selecting the highlights button shows the user a few of the loud volume segments of the stored program. In one embodiment, selecting the highlights button shows the user a few seconds of the beginning or the middle or the end of the stored program. In one embodiment, a highlight is created when the recorder system determines which segments of the stored program to play. In one embodiment, a highlight is created when the multimedia control system determines which segments of the stored program to play.

In one embodiment, the multimedia control system processor controls one or more multimedia devices in response to user inputs from the touch-screen display. In one embodiment, the multimedia control system processor controls a multiple channel parallel digital video recorder system as described above. In one embodiment, the multimedia control system processor provides a dialog-type display in response to user selection of a stored program displayed in a matrix format as described above. In one embodiment, the multimedia control system processor updates the touch-screen display to indicate the currently stored content of on the multiple channel parallel digital video recorder system.

In one embodiment, the multimedia control system is configured to display a mailbox button. In one embodiment, the user selects the mailbox button to display the available mailboxes. In one embodiment, the multimedia control system is configured to password protect mailboxes. In one embodiment, the user selects a mailbox to review programming stored in that mailbox. In one embodiment, the user selects a mailbox to review recommendation messages from other users or remote individuals. In one embodiment, the user selects a mailbox to review upsell messages.

In one embodiment, the recorder system includes a processor for controlling the system. In one embodiment, the recorder system includes a plurality of hard-drives for storing programming content and other software. In one embodiment, the recorder system includes a plurality to television and/or radio tuners. In one embodiment, the recorder system includes a plurality of analog and digital tuners. In one embodiment, the plurality of tuners includes settop boxes that receive and decode digital programming signals. In one embodiment, the recorder system includes a plurality of multi-channel cable/satellite/internet television decoder and/or analog turners. In one embodiment, radio and television feeds are provided through an interne protocol stack. In one embodiment, the recorder system includes a plurality of dynamic flash memory. In one embodiment, the recorder system stores programming content in flash memory. In one embodiment, the recorder system stores programming content within a hard-drive. In one embodiment, the recorder system stores programming content in both flash memory and on a hard-drive. In one embodiment, the recorder system includes a DVD reader and writer drive.

In one embodiment, the recorder system includes a plurality of audio and video output interfaces. In one embodiment, the recorder system includes a radio-frequency interface for connecting to a communications network or local area network. In one embodiment, the recorder system includes a local area network interface for connecting to a local area network. In one embodiment, the recorder system includes an InfraRed interface for connecting to a plurality of remote control devices. In one embodiment, the recorder system includes an output display for presenting information to the user. In one embodiment, the recorder system includes a plurality of input controls for user to control the recorder system. In one embodiment, the recorder system includes a plurality of interfaces for connecting to portable media storage devices or portable media reviewing devices.

### BRIEF DESCRIPTION OF THE DRAWINGS

FIG. 1 shows a multiple channel parallel digital video recorder system used in connection with a multimedia entertainment system and a multimedia control system.

FIG. 1B shows one embodiment of the multiple channel parallel digital video recorder system.

FIG. 2 is a block diagram of the multiple channel parallel digital video recorder system.

FIG. 3A is a block diagram showing one embodiment of the storage medium wherein the recorder system begins recording at the beginning of the storage medium when the system has reached the end of the storage medium.

FIG. 3B is a block diagram showing one embodiment of the storage medium wherein the recorder system records then deleted programming content or records over stored programming content marked for deletion thereby leaving some previously stored programs on the storage medium.

FIG. 4 shows one embodiment of a display screen showing a listing of stored programming content wherein the multimedia control system receives the stored programming content information from the recorder system.

FIG. 5 is shows one embodiment of a display screen that allows the user to build a favorite channels list. Also shown is one embodiment of a dialog box allowing the user to build other favorite channel lists.

FIG. 6 shows one embodiment of a display screen listing the various available favorite channels lists along with a dialog box that allows the user to set the time period for recording for each favorite channels list.

FIG. 7 shows one embodiment of a display screen of an upsell channel recommendation along with a dialog box showing the user an updated list of channels within the favorite channels list of the user.

FIG. 8A shows a flow diagram of one embodiment of building within the recorder system a highlights program segment for the user.

FIG. 8B shows a flow diagram of one embodiment of using the multimedia control system to build a highlights program segment for the user.

FIG. 9 shows a diagram representing one embodiment of how the recorder system connects through a communications network to the remote server. The diagram also shows one embodiment of how individuals program the remote server.

### DETAILED DESCRIPTION

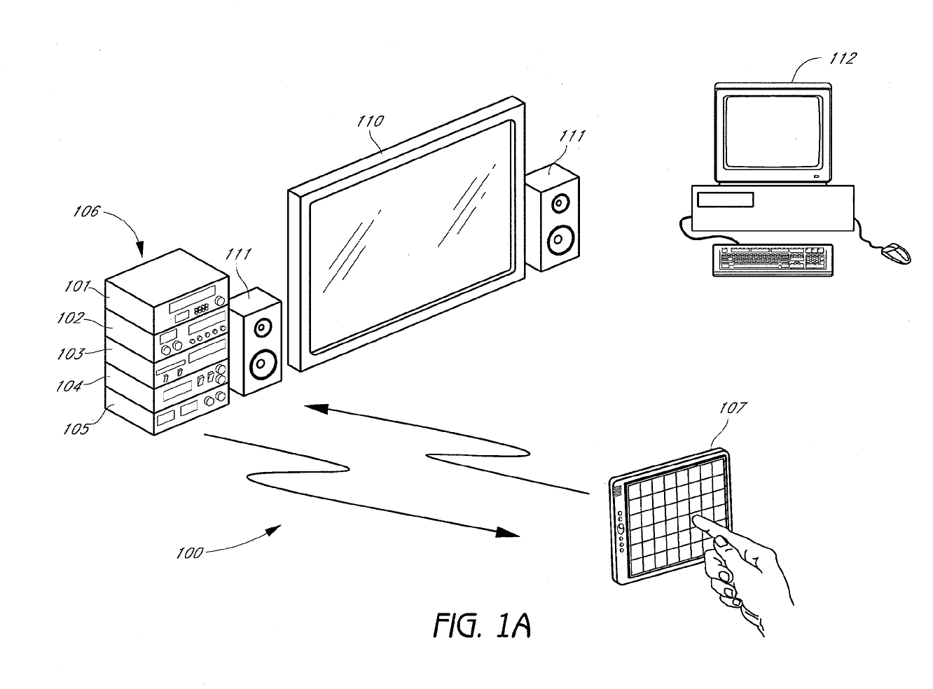

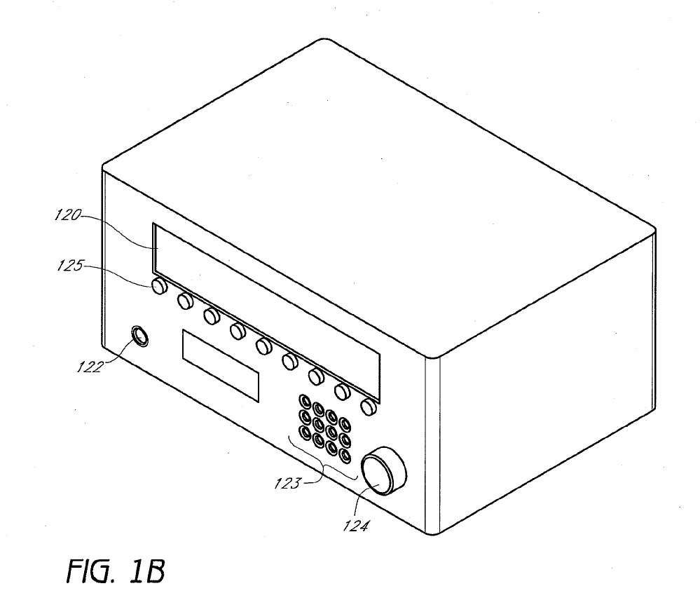

FIG. 1A shows a multiple channel parallel digital video recorder system 101 used in connection with entertainment system 106. The entertainment system 106 typically includes a television 110, audio speakers 111, and one or more multimedia devices, such as, for example, a settop box (STB) 102, an analog tape recorder 103, a DVD player 104, an AV receiver 105, etc. The recorder system 101 is used to store programming content for display on a television 110 or played on audio speakers 111. A user uses the control system 107 to perform remote control-type functions (e.g., control volume, control the channel, select the input device, fast-forward, reverse, slow motion, etc.) In one embodiment, the control system 107 provides a touch-screen display that provides information regarding programming content stored in the storage medium of the recorder system 101. In one embodiment, the control system 107 provides programmable touch-screen buttons to allow the user to control the entertainment system. In one embodiment, the control system 107 provides the functions of a universal remote control and the functions typically provided by on-screen programming.

In one embodiment, the recorder system 101 is configured to be programmed through an “on screen” programming screen that is displayed on a television 110. The recorder system 101 can be configured to be programmed through a touch screen programming screen on a multimedia control system 107. In one embodiment, the recorder system 101 is configured to be programmed on any personal computer or video game system or other computer systems 112 that connects the recorder system 101 either directly or through a communications network. The recorder system 101 can be configured to be programmed through a combination of “on-screen” programming screen, touch screen programming screen or a computer system.

In one embodiment, the multimedia control system 107 communicates with the recorder system 101 using wireless radio-frequency communication. The multimedia control system 107 can, optionally, communicate with the recorder system 101 wirelessly, via InfraRed, ultrasonic, radio frequency communications, and the like. In one embodiment, the multimedia control system 107 can optionally communicate with the recorder system 101 over wires or coaxial cable. In one embodiment, the multimedia control system 107 communicates with the recorder system 101 using a combination of the above communication interfaces. Using wireless radio-frequency communication between the multimedia control system 107 and the recorder system 101 means that the user does not have to “point” the multimedia control system 107 at the recorder system 101, as is common with InfraRed devices.

FIG. 1B shows one embodiment of the multiple channel parallel digital video recorder system 101. In one embodiment, the recorder system 101 includes a display output 120 used for displaying information to the user, such as if the system is on or off, if the system is playing the user's selected programming content. The recorder system 101 can include a DVD reader and writer drive 121, which is used for playing DVD discs and recording stored programming content to a DVD disc. In one embodiment, the recorder system 101 includes a power button 122 for turning the system on and off. The recorder system 101 optionally includes input and output interfaces for connecting the recorder system 101 to portable storage media devices, such as USB flash memory sticks, or for connecting to portable reviewing devices, such as MP3 players. In one embodiment, the recorder system 101 includes a multiple use dial button 124, which is used for allowing the user to select between different options presented on the display output 120. In one embodiment, the recorder system 101 includes an array of multiple use front panel buttons 125, which allows the user to make different selections, such as selecting the setup menu.

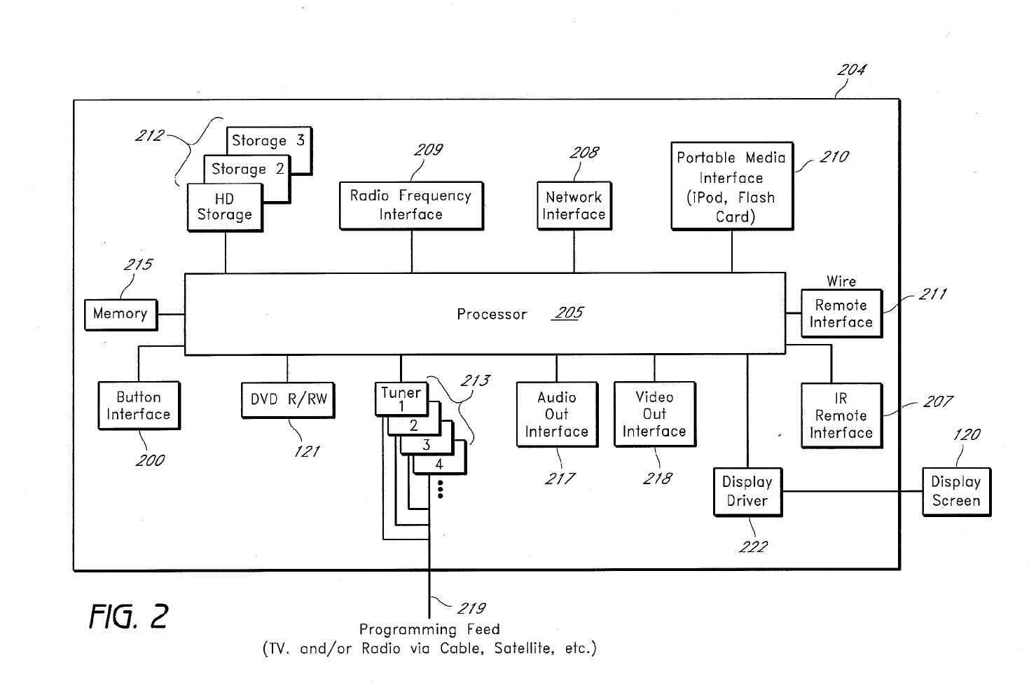

FIG. 2 is a block diagram of the multiple channel parallel digital video recorder system 101. The recorder system 101 includes a control module 204 and a screen display 120. The display screen 120 connects to and is controlled by a display driver 222, which is a part of control module 204. The display driver 222 is provided to a processor 205. A multiple use front panel buttons interface 200, an optional InfraRed communications interface 207, a network interface 208, a radio-frequency interface 209, a portable storage media interface 210, and an optional wire remote interface 211 are also provided to the processor 205. A non-volatile storage medium, such as a plurality of hard-drives, non-volatile flash memory, etc., is also provided to the processor 205. A plurality of tuners 213, a an optional flash memory 215, an optional DVD reader/writer, an audio output interface 217, and a video output interface 218 are also provided to the processor 205. The network interface 208 can be configured as a wireless LAN interface. In one embodiment, the plurality of tuners 213 includes analog tuners and/or multi-channel cable/satellite/internet television decoders.

An operating system processed on a processor 205 controls the operations of the recorder system 101. The operating system controls multiple use the front panel buttons interface 200 and processes inputted information received through the multiple use front panel buttons 125. The operating system also controls the information displayed on the display screen 120 through the display driver 222.

The plurality of tuners 213 receives the programming feeds 219 from cable/satellite/internet television networks, etc. The plurality of tuners 213 provides programming content as storable data to the processor 205. The plurality of tuners 213 allows the recorder system 101 to record multiple channels of programming in parallel. In one embodiment, the processor 205 stores the programming content in the storage medium 212. In one embodiment, the storage medium 212 is a plurality of hard-drives. In one embodiment, the processor 205 stores the programming content in the flash memory 215.

A television display can be connected to the output interfaces 217 and 218. The processor 205 retrieves programming content data from the storage medium 212 and converts the data into a television compatible signal.

In one embodiment, the processor 205 sends and receives information from the multimedia control system 107 through the radio frequency interface 209. The processor 205 can also send and receive information from the multimedia control system 107 through the network interface 208. In one embodiment, the processor 205 sends and receives information from the multimedia control system 107 through the wire remote interface 211. In one embodiment, the processor 205 sends and receives information from the multimedia control system 107 through a wireless interface, such as, for example, the InfraRed interface 207.

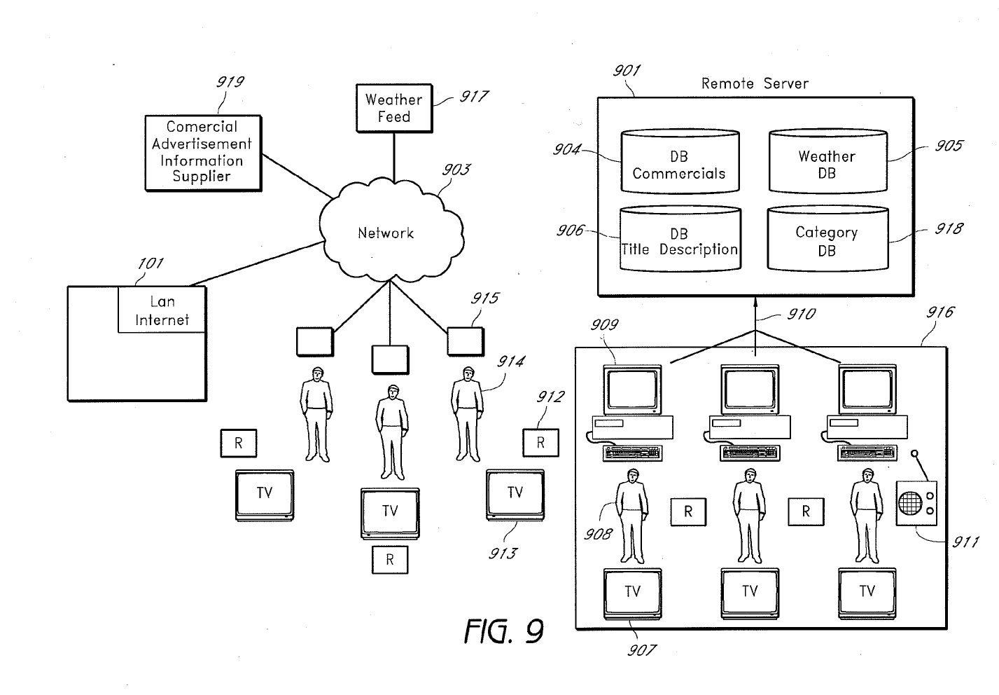

In one embodiment, the processor 205 sends and receives information from a remote server, as described in FIG. 9, through the network interface 208. The processor 205 can also send information to the remote server, as described in FIG. 9.

The processor 205 can retrieve programming content data from the storage medium 212 and sends the data to DVD reader and writer drive 121 for storing the data on a DVD disc medium. The processor 205 retrieves programming content data from the storage medium 212 and converts the data into a DVD format. In one embodiment, the processor 205 sends the converted data to the DVD reader and writer drive 121 for storing the data on a DVD disc medium.

In one embodiment, the processor 205 receives and sends data from portable mediums, for example, MP3 players or USB memory sticks, through the portable medium interface 210. In one embodiment, the processor 205 retrieves programming content data from the storage medium 212 and sends the data to a USB memory stick through the portable medium interface 210. In one embodiment, a user connects the USB memory stick to another device for reviewing the programming content.

In one embodiment, the recorder system 101 is configured to record programming content at multiple levels of resolution. In one embodiment, the processor 205 is configured to record programming content at a low resolution when the recorder system 101 is continuously recording the user's favorite channels list. In one embodiment, the processor 205 is configured to record programming content at a high resolution when the recorder system 101 is recording programming content that the user has specifically programmed that recorder system 101 to record. In one embodiment, the processor 205 is configured to record programming content utilizing multiple levels of compression algorithms stored in storage medium 212. In one embodiment, the processor 205 is configured to record programming content using a high compression algorithm when the recorder system 101 is continuously recording the user's favorite channels list. In one embodiment, the processor 205 is configured to record programming content using a low compression algorithm when the recorder system 101 is recording programming content that the user has specifically programmed to the recorder system 101 to record.

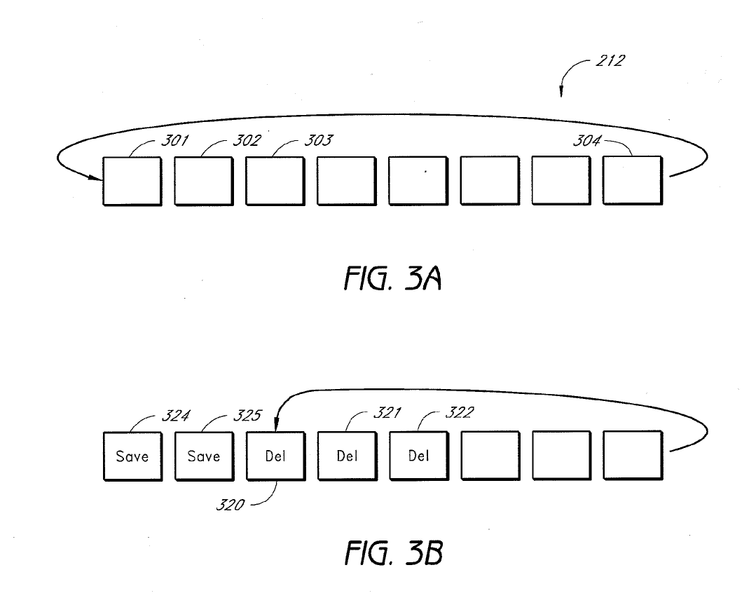

FIG. 3A is a block diagram showing one embodiment of the storage medium 212 wherein the recorder system begins recording at the beginning of the storage medium when the system has reached the end of the storage medium. In one embodiment, the memory block 301 contains programming content recorded from the programming feed 219 during a first period, whereas the memory block 302, 303, etc., contain programming content recorded from the programming feed 219 during a second, a third, etc., periods. The processor 205 continues to store programming content in the storage medium 212 until the last memory block 304 is filled, at which point the processor 205 returns to the beginning of the storage medium 212 and records over previously recorded memory block 301.

FIG. 3B is a block diagram showing one embodiment of the storage medium 212 wherein the processor 205 records over the deleted programming content 320, instead of returning to and recording over the beginning memory block 324. In one embodiment, the user selectively deletes programming content stored on the memory block 320. This allows the user to store programming content while allowing the processor 205 to continuously record additional programming content. In one embodiment, programming content is not deleted from the memory block 322 but rather memory block is marked for deletion, thereby, allowing the processor 205 to record over the contents contained in the memory block 322.

In one embodiment, the processor 205 records within the storage medium 212, a running list of programming content that the user has selected to review. In one embodiment, the processor 205 categorizes the programming content on the running list of programming content that the user has reviewed in the past. In one embodiment, the processor 205 generates and stores a list of the categories of programming most reviewed by the user. In one embodiment, the processor 205 compares the list of the categories of programming most reviewed by the user with the category of a particular program stored with the storage medium 212. In one embodiment, the processor 205 deletes or tags the particular program stored within the storage medium 212 when the category of the particular programming content does not match one of the categories listed in the list of categories of programming most reviewed by the user. In one embodiment, the processor 205 retrieves category information for a particular program from a title and description database located on a remote server, as described in FIG. 9. In one embodiment, the processor 205 deletes portions of program where the category of the deleted portion of the program does not match a category on the list of the categories of programming most reviewed by the user. In one embodiment, the processor 205 prioritizes the deletion of programming content stored on the storage medium 212 based on the list of the categories of programming most reviewed by the user.

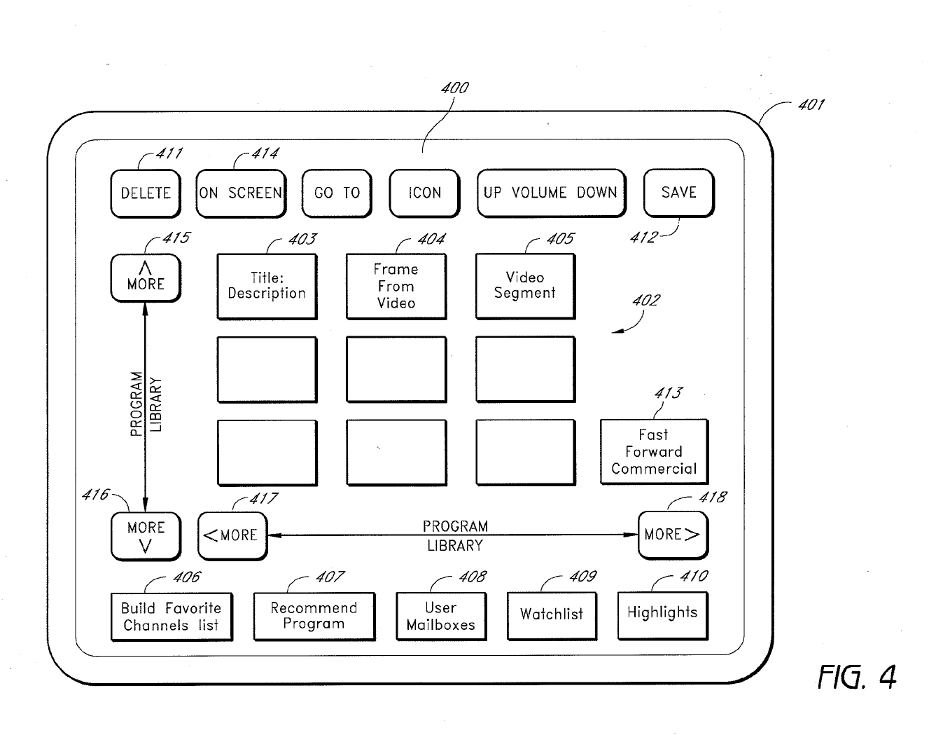

FIG. 4 shows one embodiment of the multimedia control system 107 that includes a display page 400 on a touch-screen 401. In one embodiment, the display page 400 shows a listing of stored programming content wherein the multimedia control system 107 receives the stored programming content information from the recorder system 101. In one embodiment, the display page 400 includes a matrix 402 of graphical user interface buttons that correspond to different stored programming content in the storage medium 212. The graphical user interface buttons correspond to areas on a touch-screen 401. In the example shown in FIG. 4, a button 403 corresponds to a particular programming content stored in the storage medium 212. In one embodiment, button 403 displays the title and description information corresponding to this programming content. In one embodiment, this information is retrieved from the recorder system 101. In one embodiment, the multimedia control system 107 retrieves this information from remote server, as described in FIG. 9. In one embodiment, the button 404, which corresponds to another program stored within the storage medium 212, displays one video frame from the video program. In one embodiment, the multimedia control system 107 retrieves the information corresponding to the one video frame from the recorder system 101.

In one embodiment, the matrix 402 displays all the available programming content that has been recorded, such that the user can review and mark the programming content that the user wishes to later review. In one embodiment, the user once touches the button 403 and 405 and then once touches the button 412 to save the selected programming content for later viewing. In one embodiment, the recording system 101 will not record over the programming content when the user selects the programming content to be saved and protected from being recorded over. In one embodiment, the recorder system 101 is configured to allow the user to specify a period of time for saving the programming content that the user has selected to save, such that after this period expires the recording system will record over the saved and protected programming content. In one embodiment, the recorder system 101 is configured to allow the user to permanently save or save indefinitely the selected programming content. In one embodiment, the recorder system 101 is configured to allow the user to store the selected programming content on a portable storage medium, for example, a memory stick or DVD disc. In one embodiment, the recorder system 101 is configured to record over the saved and protected programming content after a period of time set by the user during the initial setup of the recorder system 101. In one embodiment, the recorder system 101 is configured to record over the saved and protected programming content after a default period of time set by the manufacturer.

In one embodiment, the button 405, which corresponds to yet another program stored within the storage medium 212, displays a video segment that corresponds to the stored program. In one embodiment, the buttons 403, 404, 405, etc., within matrix 402 simultaneously play their corresponding video content. In one embodiment, the user touches the button 403 once, which causes the multimedia control system 107 to send a signal to the recorder system 101 to play the audio content corresponding to the button 403. In one embodiment, the user selects the button 404 to review the display screen 400 on the television 110. In one embodiment, the user reviews the buttons 403, 404, 405, etc., within matrix 402 that simultaneously play their corresponding video content. In one embodiment, the user twice selects button 403 to play the programming content corresponding to the button 403. In one embodiment, the display page 400 is configured to present in buttons 403, 404, 405, etc., the available live programming content received from the programming feeds 219. In one embodiment, the display page 400 that presents the available live programming content is displayed within the multimedia control system 107 or on the television 110. In one embodiment, the user twice selects the button 403 on the multimedia control system 107 to display on the television 110 the live programming content corresponding to the button 403. In one embodiment, the buttons 403, 404, 405, etc., that are simultaneously playing either stored or live programming content display programming content in low resolution.

In one embodiment, the matrix 402 displays a plurality of buttons 403, 404, 405, etc. In one embodiment, the user selects the buttons 415 and 416 to scroll up or down, thereby, allowing the user to see other available programming content. In one embodiment, the user selects the buttons 415 and 416 to scroll up or down ten buttons that correspond to programming content not currently displayed. In one embodiment, the user selects buttons 417 and 418 to scroll left and right, for example ten buttons.

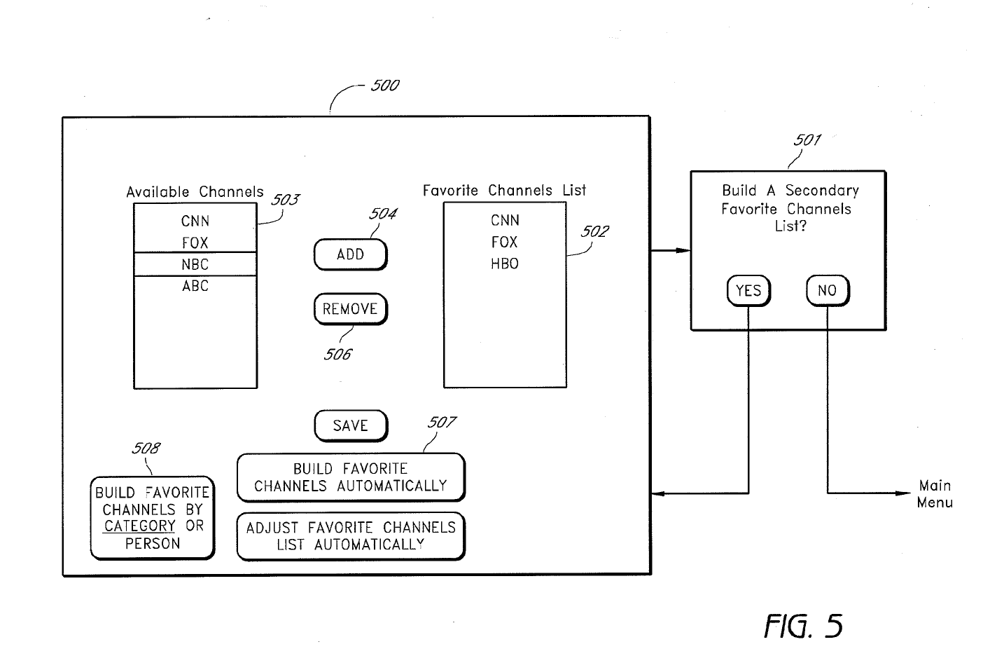

In one embodiment, the display page 400 includes button 406 which allows the user to build a favorite channels list, as shown in FIG. 5. In one embodiment, the user selecting the button 406 causes a new display page, as shown in FIG. 5, to appear and this new display page provides the user options for building a favorite channels list.

In one embodiment, the display page 400 includes the button 407 which allows the user to recommend programming content to other users or individuals at remote locations. In one embodiment, the user A once touches the button 406 corresponding to the users selected programming content and then the user once touches the button 407, causing a dialog box (not shown) to appear. In one embodiment, the dialog box provides the names of other users of the recorder system 101, thereby, allowing the user A to recommend the selected programming content to other users by selecting their names from the list. In one embodiment, the dialog box provides a list of users and other individuals located at remote locations. In one embodiment, user A's recommendation to user B is received by recorder system 101 and is stored in an electronic mailbox designated for user B. In one embodiment, user A's recommendation to individual C at a remote location causes an electronic mail message to be sent to individual C from the recorder system over a communications network.

In one embodiment, the display page 400 includes the button 408 which allows a user to access the user's electronic mailbox which is stored in the storage medium 212. In one embodiment, a user receives, from other users, a recommendation for reviewing programming content. In one embodiment, a dialog box appears when a user selects the button 408, and the dialog box lists the recommendations provided by other users. In one embodiment, the user selects a recommendation for playing the programming content. In one embodiment, the user selects to delete the recommendation.

In one embodiment, the display page 400 includes the button 409, which allows a user to create a watchlist of desired programming content. In one embodiment, a dialog box appears when a user selects the button 409 and the dialog box allows the user to input names of desired programming content. In one embodiment, the recorder system 101 receives this information from the multimedia control system 107 and stores this information within storage medium 212. In one embodiment, the recorder system 101 compares the title of a program that has been stored within the storage medium 212 with the titles inputted on the watchlist. This comparison is completed when the recorder system 101 is about to record over or delete the program. In one embodiment, the recorder system 101 sends a message to the user's electronic mailbox when the title of the program matches one of the titles on the watchlist. In one embodiment, the recorder system deletes or records over a program when the title of the program fails to match with one of the titles on the watchlist.

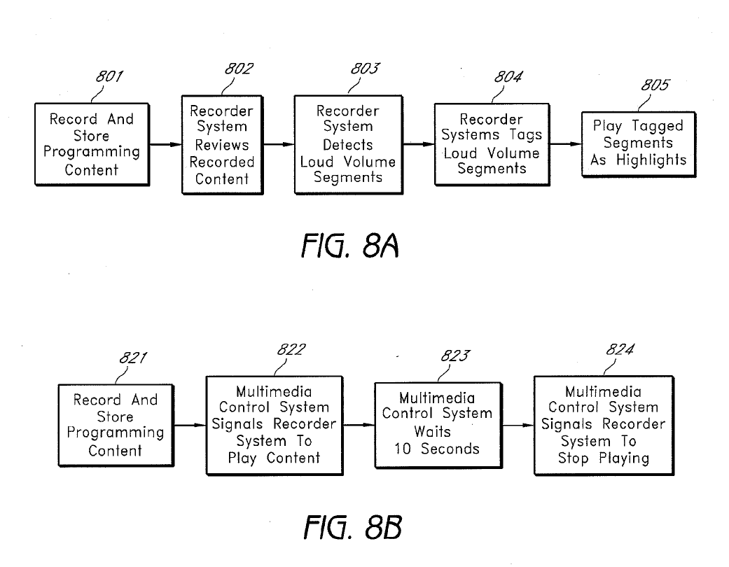

In one embodiment, the display page 400 includes the button 410, which allows the user to review a short segment of a particular program. A user can touch the button 403 to select the programming content desired, then touch the button 410 to send a command to the recorder system 101, as described in FIGS. 8A and 8B.

In one embodiment, the display page 400 includes the button 411, which allows the user to delete particular programs. The user can touch the button 403, which corresponds to the programming content that is not desired by the user, to cause a dialog box to appear. The dialog box prompts the user to confirm deletion of the selected program. In one embodiment, a signal is sent to the recorder system 101 from the multimedia control system 107 when the user confirms the deletion. The signal causes the recorder system 101 to delete the selected program or tag the selected program for deletion from the storage medium 212.

In one embodiment, the recorder system 101 is configured to allow the user to inform the recorder system 101 that a commercial advertisement is currently being presented such that the recorder system will tag the indicated portion of the stored programming content as a commercial advertisement. In one embodiment, the multimedia control system 107 includes a “fast-forward commercial” button 413 that is configured to allow the user to fast forward through a portion of a program and mark this portion as a commercial advertisement. In one embodiment, the user holds onto the “fast-forward commercial” button 413 when a commercial begins and releases the button when the commercial ends. In one embodiment, the recorder system is configured to allow the user to select the “fast-forward commercial” button 413 while the recorder system 101 is recording the programming content such that the recorder system 101 tags the programming content portion as a commercial advertisement. In one embodiment, the recorder system 101 is configured to stop recording a particular programming content while the user holds the “fast-forward commercial” button 413 in the instance where the user is simultaneously reviewing that same programming content in real time. In one embodiment, the recorder system 101 is configured to automatically delete the portion of programming content marked as commercial advertisements.

FIG. 5 is shows one embodiment of a display page 500 that allows the user to build a favorite channels list 502 from a list of available channels 503. The user selects and highlights a channel from the available channels list 503, and then selects the add button 504 to a build favorite channels list 502. The user can select a channel from the favorite channels list 502, then select the remove button 506 to delete a channel from the favorite channels list 502. The user can select the save button to store the user's favorite channels list 502 in the storage medium 212. In one embodiment, the dialog box 501 appears within the display page 500 to allow the user to build a secondary favorite channels list. The user can select button 507 to have recorder system 101 automatically build the user's favorite channels list 502. The recorder system 101 records (onto the storage medium 212) the channels that the user watches, and then the recorder system 101 automatically builds the user's favorite channels list 502 by selecting the most frequently watched channels.

In one embodiment, the display page 500 includes a button 508, which allows the user to build a favorite channels list by category. The user touches the button 508 and a dialog box appears prompting the user to select a category, for example, current events channels or sports channels. In one embodiment, the user builds a favorites channels list based on a season, for example, football season or basketball season. In one embodiment, the recorder system 101 retrieves the user's selected category information from a remote server through a communications network, as described in FIG. 9. The recorder system 101 processes the category information to build the user's favorite channels list 502.

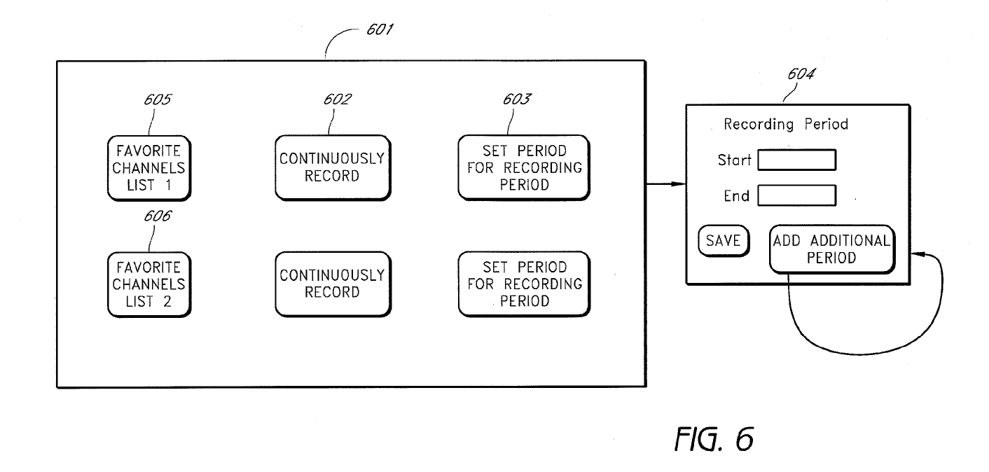

FIG. 6 shows one embodiment of a display page 601 listing the various available favorite channels lists 605 and 606. In one embodiment, the user selects the button 602 to program the recorder system 101 to record continuously and simultaneously the channels listed in the favorite channels list 605. The user can press the button 603, to program the recorder system 101 to record the channels listed in the favorite channels list 605 during a certain period. Selecting the box 603 causes the dialog box 604 to pop open to allow the user to enter a start and end time for simultaneously recording the channels listed in the favorite channels list 605.

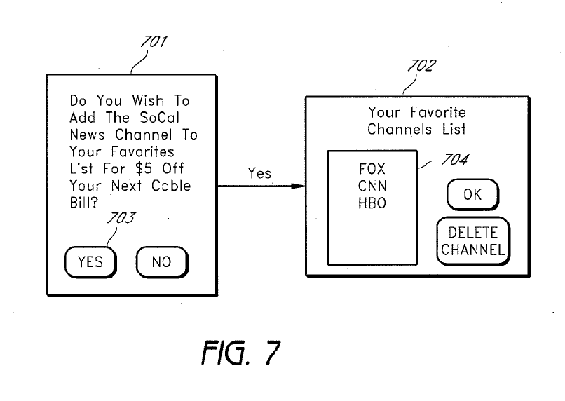

FIG. 7 shows one embodiment of a display page 701 offering the user an upsell channel recommendation. In one embodiment, the upsell channel recommendation offers the user a reward for adding a particular channel to the user's the favorite channels list 502. In one embodiment, selecting the button 703 allows the user to accept the upsell channel recommendation and causes a dialog box 702 to pop open showing the user an updated list of channels within the favorite channels list 704 of the user. In one embodiment, the user chooses to accept this channel addition or cancel the channel addition.

FIG. 8A shows a flow diagram of one embodiment of building within the recorder system a highlights program segment for the user. In one embodiment, the recorder system 101 records and stores programming content at step 801 from the programming feed 219. In one embodiment, the recorder system 101 reviews the recorded content after the content is stored at step 802. In one embodiment, the recorder system 101 performs step 802 in a batch mode at a designated time. The recorder system 101 performs step 802 after the recorder system 101 has stored the programming content in the storage medium 212. In one embodiment, the recorder system 101 detects the volume level throughout the programming content, such that when the recorder system 101 detects a volume level above a threshold volume level the recorder system 101 tags this portion of the programming content at step 804. In one embodiment, the recorder system plays the tagged portions of the programming content when the multimedia control system 107 signals the recorder system 101 to play the highlights segment of the programming content.

FIG. 8B shows a flow diagram of one embodiment of using the multimedia control system to build a highlights program segment for the user. In one embodiment, the recorder system 101 records and stores programming content at step 821 from the programming feed 219. In one embodiment, the multimedia control system 107 signals the recorder system 101 to start playing the beginning portion of the programming content selected by the user at step 822 when the user selects to play the highlights segment of a programming content. In one embodiment, the multimedia control system 107 waits for a period of time, for example 20 seconds, at step 823. In one embodiment, the multimedia control system 107 signals the recorder system to stop playing the programming content at step 824.

In one embodiment, the recorder system 101 receives a signal from the multimedia control system 107 to play the highlights segment of a programming content. The recorder system 101 plays the selected programming content for a short period of time, for example, the first 20 seconds, and then stops playing the programming content.

FIG. 9 shows a diagram representing one embodiment of a multiple channel parallel digital video recorder system 101 connecting through a communications network 903, such as the Internet, to the remote server 901. In one embodiment, the remote server 901 includes a database 904 for storing information related to the start and end times of commercials. In one embodiment, the remote server 901 includes a database 905 for storing information related to weather conditions in different cities around the world. In one embodiment, the remote server 901 includes a database 906 for storing information related to the title and description of various programs aired by programming distributors.

In one embodiment, the individuals 908 located in a central location 916, such as an office building, review particular channels on the televisions 907 and the radios 911 and then input into the computers 909 the start and end times of commercials that are presented on the channels. Data inputted in the computers 909 is stored in the commercial information database 904 by connecting to the remote server 901 through a local area network 910. In one embodiment, the individuals 914, located at remote locations, review the televisions 913 and the radios 912, and input into the computers 915 the start and end time of commercials that are presented on the channels. Data inputted in the computers 915 transmitted to the remote server 901 over the communications network 903 and is stored in the commercial information database 904. The individuals 908 and 914 can input title and description and date and start and end time information into the title and description information database 906. The remote server 901 receives from the communications network 903 weather information for cities around the world from the weather information provider 917, and the remote server 901 stores this weather information within the weather information database 905. The recorder system 101 retrieves category information from the category information datable 918 located in the remote server 901.

In one embodiment, the recorder system 101 is configured to send to the remote server 901 the commercial tagging information derived from the user by holding the “fast-forward commercial” button 413 on multimedia control system 107. The recorder system 101 sends the commercial tagging information to the remote server 901 through the communications network 903 for storage in the commercial information database 904. In one embodiment, the remote server 901 is configured to receive a plurality of commercial tagging information from a plurality of users over the communications network 903. The remote server 901 can be configured to average the commercial tagging information received from a plurality of users such that anomalies are eliminated. The remote server 901 can be configured to delete commercial tagging information received from a plurality of users that is dissimilar to other information received from other users. The remote server 901 can also be configured to apply an algorithm to the plurality of commercial tagging information received from a plurality of users so as to determine the start and end timing information for commercial advertisements.

In one embodiment, the remote server 901 receives commercial advertisement information from a commercial advertisement information supplier entity 919 through the communications network 903 and stores this information in the commercial information database 904. In one embodiment, the remote server 901 is configured to send commercial advertisement information that is stored in the commercial information database 904 to recorder system 101 and/or multimedia control system 107.

In one embodiment, the remote server 901 is configured to send program information, such as, for example: program title, description, program start time, program end time, program start date, etc., to the recorder system 101 and/or multimedia control system 107. The recorder system 101 uses the commercial advertisement information and/or the title and description and date and start and end time data information to associate with programming content stored in the recorder system 101. In one embodiment, the multimedia control system 107 uses the commercial advertisement information and/or the title and description and date and start and end time data information to associate with programming content stored in the recorder system 101. The recorder system 101 can use the commercial advertisement information and/or the title and description and date and start and end time data information to determine the start and end point of programming content stored in the recorder system 101. In one embodiment, the multimedia control system 107 uses the commercial advertisement information and/or the title and description and date and start and end time data information to the start and end points of programming content stored in the recorder system 101. By using the program information, the recorder system 101 can provide various user functions, such as, for example: skip commercials, jump to beginning of program, jump to next program, jump to end of program, etc. The recorder system 101 can also, use the programming information in connection with the display screen 107 to allow the user to view a list (or matrix) of stored programs and select a desired stored program by name, genre, etc. The user can also use the display screen 107 to select programs to be deleted, programs to be saved, etc. In one embodiment, the user can select programs on the display screen 107 and indicate that the selected programs are to be stored in a specific folder or under a user specified heading.

Although various embodiments have been described above, other embodiments will be within the skill of one of ordinary skill in the art. Thus, the invention is limited only by the claims that follow.

What is claimed is:

1. A multiple channel parallel video recorder system, comprising:
a processor;
a data storage medium provided to the processor;
a plurality of tuners provided to the processor, the plurality of tuners configured to receive one or more programming feeds; and
a communications interface provided to the processor, wherein the processor is configured to receive from the plurality of tuners a plurality of signals of programming content data, wherein the processor is configured to store the plurality of signals of programming content data on the data storage medium, and wherein the processor is configured to store the plurality of signals of programming content data over the oldest non-protected data stored on the data storage medium.

2. The multiple channel parallel video recorder system of claim 1, wherein the processor is configured to receive from a remote server commercial information, wherein the processor is configured to process the commercial information to delete or tag commercial content data within the programming content data.

3. The multiple channel parallel video recorder system of claim 1, wherein the plurality of tuners comprises a plurality of tuners configured to receive broadcast television.

4. The multiple channel parallel video recorder system of claim 1, wherein the plurality of tuners comprises a plurality of tuners configured to receive digital television.

5. The multiple channel parallel video recorder system of claim 1, wherein the plurality of tuners comprises a plurality of tuners configured to receive radio broadcast.

6. The multiple channel parallel video recorder system of claim 1, wherein the plurality of tuners comprises a plurality of tuners configured to receive Internet television.

7. The multiple channel parallel video recorder system of claim 1, wherein the plurality of tuners comprises a plurality of tuners configured to receive satellite television

8. The multiple channel parallel video recorder system of claim 1, wherein the plurality of tuners comprises a plurality of tuners configured to receive cable television.

9. A method for recording a plurality of programming channels, comprising:
receiving programming content data from a plurality of tuners;
storing the programming content data in a storage area the storage area is full and then storing new programming content data over oldest programming content in said storage area;
downloading program information related to programming content stored in said storage area, wherein said program information comprises program start times for various different programs in said programming content; and
determining a start and end time for commercials in said programming content.

10. The method of claim 9, further comprising replaying said programming content without commercials.

11. The method of claim 9, further comprising displaying a list of programming content stored in said storage area.

12. The method of claim 9, further comprising deleting commercials stored with said programming content.

13. The method of claim 9, wherein said determining a start and end time of commercials stored with said programming content comprises downloading commercial start and end times from a server.

14. The method of claim 9, wherein said determining a start and end time of commercials stored with said programming content comprises receiving user inputs.

15. The method of claim 9, wherein said determining a start and end time of commercials stored with said programming content comprises receiving user input from a fast-forward through commercial user control.
